(19) United States
(12) Patent Application Publication
(10) Pub. No.: US 2006/0146694 A1
(43) Pub. Date: Jul. 6, 2006

(54) Program and method for verifying reliability of network

(75) Inventors: Shinji Hamaguchi, Kato (JP); Fumikazu Fujimoto, Kato (JP); Yasushi Kishimoto, Kato (JP); Noriaki Matsuzaki, Kato (JP); Hiroki Ohashi, Kato (JP); Keiko Usunaga, Kato (JP); Hideaki Hasegawa, Kato (JP); Soichi Takeuchi, Kato (JP); Hideyuki Tanaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/089,217

(22) Filed: Mar. 25, 2005

(30) Foreign Application Priority Data
Dec. 16, 2004 (JP) 2004-364657

(51) Int. Cl. H04L 12/28

(52) U.S. Cl. 370/216; 370/254

(57) ABSTRACT

A reliability verification program that enables network administrators to verify the redundancy of a system that they operate. With reference to network configuration data describing physical connections of a network system, the program selects a source device and a destination device as a start point and an end point of access routes. A verification route is then determined by tracing the physical connections from the selected source device to the selected destination device. Based on the network configuration data, the program creates network configuration verification data by excluding data about devices and physical links involved in the determined verification route. This network configuration verification data is used to find a redundant route from the source device to the destination device. The presence of a redundant route corresponding to the verification route means that the network system has good redundancy in its physical connections.

### CROSS-REFERENCE TO RELATED APPLICATIONS

This application is based upon and claims the benefits of priority from the prior Japanese Patent Application No. 2004-364657, filed on Dec. 16, 2004, the entire contents of which are incorporated herein by reference.

### BACKGROUND OF THE INVENTION

1. Field of the Invention

The present invention relates to a program and method for verifying reliability of a network system. More particularly, the present invention relates to a reliability verification program and method for evaluating redundancy of network devices and links.

2. Description of the Related Art

Some types of network systems are designed to have redundant device-to-device connections in order to provide clients with more reliable services. In such systems, network devices are interconnected through multiple signal transmission routes, so that an alternative route will take over a failed route, without disrupting communication between devices. In a storage area network (SAN) environment, for example, this feature is implemented by deploying multiple redundant physical links for server-storage connections.

Redundancy of physical transmission routes greatly contributes to improved reliability of communication. Stated in reverse, the overall reliability of a network system is determined by whether it has redundant signal transmission routes. Some researchers propose techniques for evaluating reliability of a network in this aspect (see, for example, Japanese Unexamined Patent Publication No. 2003-67432).

As network systems grow, their management becomes more and more difficult because of increased complexity of physical network structure, imposing a larger burden on network administrators. In some cases, an oversight of incorrect links between network elements leads to a degraded redundancy even though the system is originally designed to have redundant routes for signal transmission. Network systems, however, are often so complicated that users are unable to find such errors with visual inspection.

Besides using the physical links discussed above, network devices need to set up logical paths so as to communicate with each other. Such logical paths, called “access paths,” are defined at the source end (i.e., devices that initiate access). More specifically, a server sets up an access path to a storage device in order to make access to data in that storage device.

Access paths have also to be redundant to ensure the system reliability; inappropriate path setup could spoil the redundancy of the system. In a SAN system, for example, servers define their own redundant access paths to remote storage devices according to instructions from an administrator. Those access paths can be protected by their redundancy only if they have no overlapped portion on their physical routes. In other words, a flaw in access path setup would lead to a lack of redundancy even if the physical network links are designed to be redundant.

As can be seen from the above discussion, it is difficult to ensure the redundancy in multiple access paths in a SAN environment, and an incorrect path setup could impair the system's reliability and availability. For this reason, existing SAN systems are sometimes forced to stop operations due to a problem with their network devices although those systems are supposed to be redundancy protected from a single-point failure. When network administrators are mistakenly confident about the redundancy of their network, they would never notice the flaw of their system until it actually stops because of some failure in a non-redundant portion, which results in a long network downtime.

### SUMMARY OF THE INVENTION

In view of the foregoing, it is an object of the present invention to provide a reliability verification program and a reliability verification method that enable network administrators to verify the redundancy of a system that they operate.

To accomplish the above object, the present invention provides a computer-readable storage medium storing a reliability verification program for verifying reliability of a network system. This program causes a computer to function as the following elements: a selector, a verification route determiner, a redundant route finder, and a physical connection redundancy determiner. The selector selects a source device and a destination device as a start point and an end point of access routes, with reference to network configuration data describing physical connections of the network system. The verification route determiner determines a verification route by tracing the physical connections described in the network configuration data from the source device to the destination device. The redundant route finder first creates network configuration verification data from the network configuration data by excluding data about devices and physical links involved in the verification route that the verification route determiner has identified. The redundant route finder then searches the created network configuration verification data to find a redundant route from the source device to the destination device. The physical connection redundancy determiner determines that the network system has redundancy in physical connections if the redundant route finder has successfully found a redundant route corresponding to the verification route.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a conceptual view of the present invention.

FIG. 2 shows a system configuration according to an embodiment of the present invention.

FIG. 3 shows an example hardware configuration of a computer platform for an administration server of the present embodiment.

FIG. 4 is a block diagram showing functions of the administration server.

FIG. 5 shows a conceptual model of a SAN system analyzed by a configuration manager.

FIG. 6 shows an example data structure of a network configuration database.

FIG. 7 is a diagram representing a SAN system.

FIG. 8 is a flowchart of a physical link verification process.

FIG. 9 shows a process of data analysis according to a related configuration extraction procedure.

FIG. 10 is a flowchart of a process of preparing redundancy verification data.

FIG. 11 shows an example data structure of related configuration data.

FIG. 12 shows an example data structure of redundancy verification data.

FIG. 13 shows a SAN system representation based on related configuration data.

FIG. 14 shows a SAN system representation based on redundancy verification data.

FIG. 15 shows how to find a route on redundancy verification data.

FIG. 16 shows a verification route that is found.

FIG. 17 shows redundancy verification data which excludes devices and ports involved in the verification route.

FIG. 18 shows a logical process of finding a redundant route.

FIG. 19 shows how to find a redundant route on redundancy verification data.

FIG. 20 shows an unsuccessful result of redundant route search.

FIG. 21 shows how to find another route on redundancy verification data.

FIG. 22 shows a verification route found in the second search.

FIG. 23 shows redundancy verification data which excludes devices and ports involved in the verification route found in the second search.

FIG. 24 shows how to find a redundant route on redundancy verification data.

FIG. 25 shows a redundant route that is found.

FIG. 26 shows a first example of multipath access.

FIG. 27 shows a second example of multipath access.

FIG. 28 shows an example result of a physical link verification performed for determining a redundancy level.

FIG. 29 shows an example of dual redundant access paths.

FIG. 30 shows an example of access paths with poor redundancy.

FIG. 31 shows an example result of a physical link verification performed for extracting groups of shortest routes.

FIG. 32 shows an example SAN system with two switches.

FIG. 33 shows an example SAN system with direct server-storage connections.

FIG. 34 shows an example SAN system with switches connected in a ring topology.

FIG. 35 shows an example SAN system with switches connected in a partial mesh topology.

FIG. 36 shows an example SAN system with switches connected in a full mesh topology.

FIG. 37 shows an example SAN system configured in a core/edge topology with multiple core switches.

FIG. 38 shows an example SAN system where multiple redundant routes pass through the same set of cascaded switches.

FIG. 39 shows an example SAN system where multiple redundant routes pass through the same switch.

FIG. 40 shows an example SAN system where a storage device is connected only to one switch.

FIG. 41 shows an example SAN system configured in a core/edge topology with a single core switch.

### DESCRIPTION OF THE PREFERRED EMBODIMENTS

Preferred embodiments of the present invention will be described below with reference to the accompanying drawings, wherein like reference numerals refer to like elements throughout. The description begins with an overview of the present invention and then proceeds to more specific embodiments of the invention.

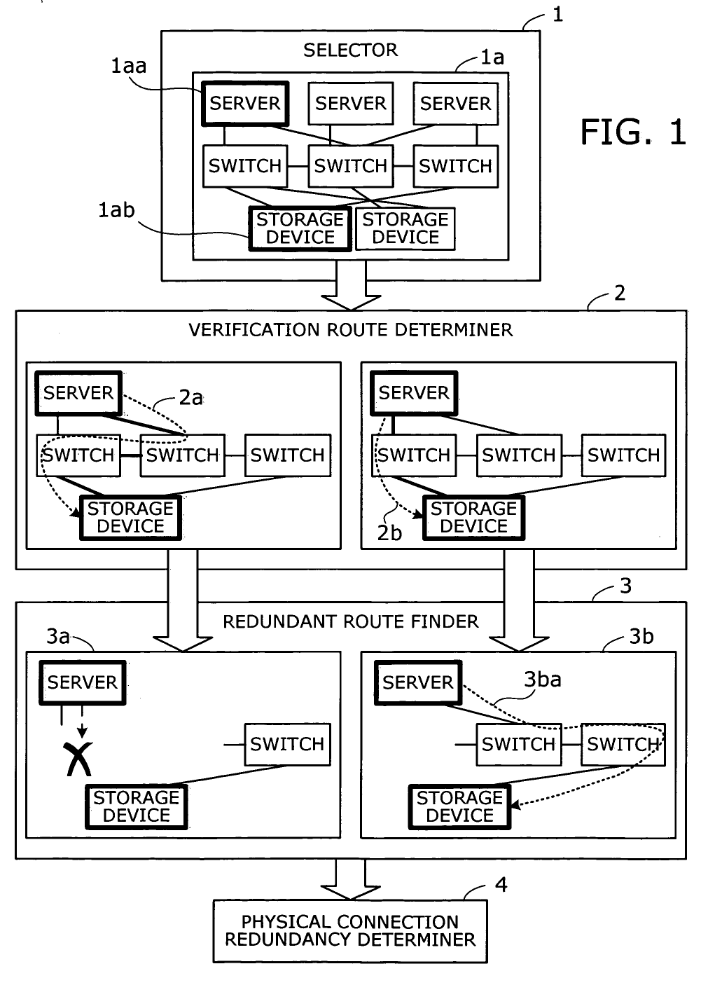

FIG. 1 is a conceptual view of the present invention. The present invention enables a computer system to function as a selector 1, a verification route determiner 2, a redundant route finder 3, and a physical connection redundancy determiner 4. These elements provide the functions described below.

The selector 1 selects a source device 1aa and a destination device 1ab as start and end points of access routes, with reference to network configuration data 1a describing physical connections of a given network system. This selection is made in response to, for example, a user command. The verification route determiner 2 traces physical connections described in the network configuration data 1a, from the selected source device 1aa to the selected destination device 1ab, thereby identifying verification routes 2a and 2b. In the case where the source device 1aa and destination device 1ab have two or more ports, as in the example illustrated in FIG. 1, the verification route determiner 2 attempts to determine multiple verification routes corresponding to the individual source and destination ports.

More specifically, in the example shown in FIG. 1, the verification route determiner 2 chooses one port of the source device 1aa and traces the connections described in the network configuration data 1a, starting from that source port and reaching one port of the destination device 1ab. This process yields one verification route 2a. The verification route determiner 2 then selects another port of the source device 1aa and finds another verification route 2b that reaches another port of the same destination device 1ab.

The redundant route finder 3 excludes devices and physical links involved in the identified verification routes 2a and 2b from the network configuration data 1a and thereby creates network configuration verification data 3a and 3b, respectively. Subsequently the redundant route finder 3 looks into each network configuration verification data 3a and 3b in an attempt to find a redundant route from the source device 1aa to destination device 1ab. In the example of FIG. 1, the redundant route finder 3 finds a redundant route 3ba. More specifically, the redundant route finder 3 selects a source port other than that of the identified verification route 2a and then consults the corresponding network configuration verification data 3a to find a route from the selected source port to a remaining port of the destination device 1ab. This attempt actually fails, and the redundant route finder 3 now performs the same for the other verification route 2b, with reference to its corresponding network configuration verification data 3b. The second attempt yields a redundant route 3ba.

The physical connection redundancy determiner 4 determines that the network system has redundancy in its physical connections if the redundant route finder 3 has successfully found a redundant route corresponding to at least one verification route. Note that, when two or more different verification routes (e.g., routes 2a and 2b in FIG. 1) exist between given start and end points, there is no need for all of those routes to have a corresponding redundant route. From the redundancy standpoint, it is sufficient if one verification route has a redundant route. In the example shown in FIG. 1, the second verification route 2b has a redundant route 3ba, whereas the first verification route 2a does not. If none of the two verification routes 2a and 2b had a redundant route, the physical connection redundancy determiner 4 would conclude that the network system lacks redundancy. When the verification is finished, the physical connection redundancy determiner 4 can output the result on a monitor screen, for example.

In operation, the above-described components of the present invention work together as follows. First, with reference to network configuration data 1a describing physical connections of a given network, the selector 1 selects a source device 1aa and a destination device 1ab as start and end points of access paths. The verification route determiner 2 then identifies verification routes 2a and 2b from the source device 1aa to the destination device 1ab by tracing the physical connections described in the network configuration data 1a.

Subsequently, the redundant route finder 3 creates network configuration verification data 3a from the network configuration data 1a by excluding data records of devices and physical links involved in one verification route 2a that the verification route determiner 2 has identified. Likewise, it creates network configuration verification data 3b by excluding data records of devices and physical links involved in the other verification route 2b. With those network configuration verification data 3a and 3b, the redundant route finder 3 finds a redundant route 3ba, i.e., another route reaching the destination device 1ab. In the example of FIG. 1, the search on one network configuration verification data 3a yields no redundant routes, whereas the other network configuration verification data 3b provides a redundant route 3ba. With the found redundant route 3ba, the physical connection redundancy determiner 4 concludes that the network in question has good redundancy in its physical connections.

Redundancy of a network may be impaired by incorrect connection of cables or other errors, which is likely to happen when the network configuration is modified for some reason. The above-described verification mechanism aids the users to know whether their network still maintains its redundant physical connections between devices. For example, one can ensure the health of his/her network by simply running the proposed reliability verification program on a computer after the network arrangement is modified. This feature of the present invention contributes to reliable operations of a network system.

### SAN Applications

Besides verifying physical links, the present invention can also check the redundancy of multiple access paths of a particular device on a network. For example, the present invention is applied effectively to SAN systems, which provide users with data storage services on a network. This section will describe a specific embodiment of the present invention which is directed to redundancy verification for physical connections and access paths in a SAN system.

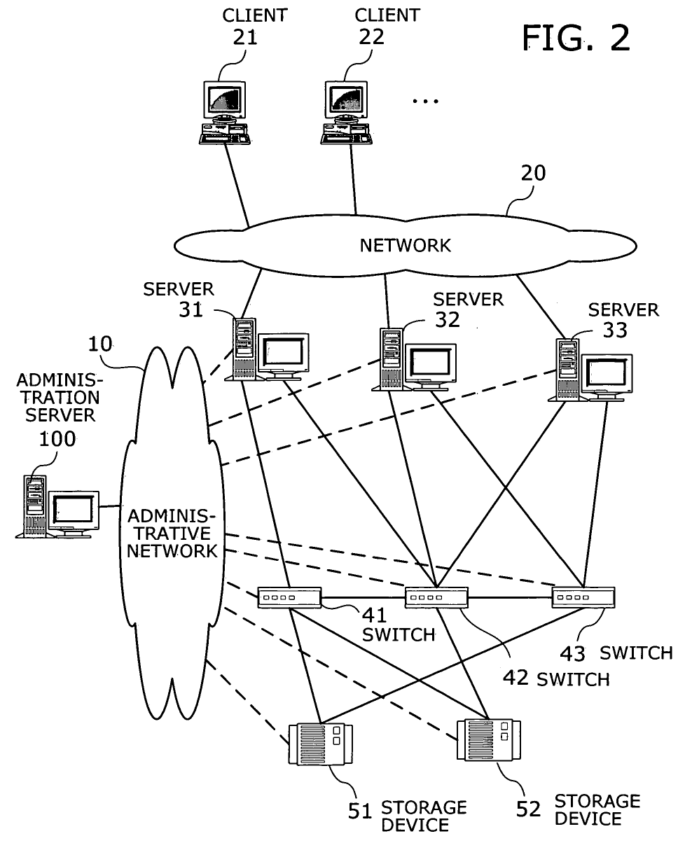

FIG. 2 shows a system configuration according to an embodiment of the present invention. The illustrated system provides clients 21, 22, and so on with SAN service. This SAN system is formed from a plurality of servers 31, 32, and 33, a plurality of switches 41, 42, and 43, and a plurality of storage devices 51 and 52.

The servers 31 to 33 are connected to clients 21, 22, and so on via a network 20. One server 31 is linked to switches 41 and 42, while the other two servers 32 and 33 are linked to switches 42 and 43. The servers 31 to 33 provide the clients 21, 22, and so on with various processing services according to their request. For example, the servers 31 to 33 may work as web servers with web application programs. Server applications use data in the storage devices 51 and 52, and when such a process is invoked, the servers 31 to 33 make access to the storage devices 51 and 52 through one of the switches 41, 42, and 43.

The switch 41 is linked to the server 31 and storage devices 51 and 52. The switch 42 is linked to the servers 31 to 33, as well as to the storage device 52. The switch 43 is linked to the servers 32 and 33, as well as to the storage device 51. Those switches 41, 42, and 43 are fiber channel switches deployed to transport data between the servers 31 to 33 and storage devices 51 and 52.

The storage devices 51 and 52 are large-capacity data storage devices, which receive and provide data from/to the servers 31 to 33 in response to their access requests received via the switches 41, 42, and 43.

The administration server 100 is connected to every component of the SAN system via an administrative network 10. This administrative network connection allows the administration server 100 to make access to SAN component devices for the purpose of various management activities. Specifically, the administration server 100 collects information about how each device is linked with other devices, so as to verify the redundancy of physical network connections. The administration server 100 also collects information about present access paths from the servers 31 to 33, so as to verify their redundancy, where the term “access path” refers to a logical path through which a server can make access to a storage device.

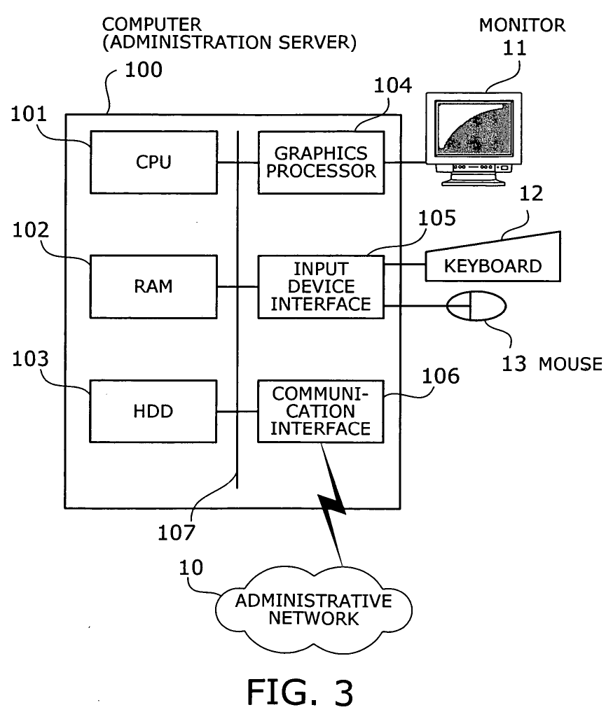

FIG. 3 shows an example hardware configuration of the administration server 100 according to an embodiment of the present invention. The illustrated administration server 100 is a computer system composed of the following functional elements: a central processing unit (CPU) 101, a random access memory (RAM) 102, a hard disk drive (HDD) 103, a graphics processor 104, an input device interface 105, and a communication interface 106. The CPU 101 controls the entire computer system, interacting with other components via a bus 107.

The RAM 102 serves as temporary storage for the whole or part of operating system (OS) programs and application programs that the CPU 101 executes, besides storing other various data objects manipulated at runtime. The HDD 103 stores program and data files of the operating system and various applications. The graphics processor 104 produces video images in accordance with drawing commands from the CPU 101 and displays them on the screen of an external monitor 11 coupled thereto. The input device interface 105 is used to receive signals from external input devices such as a keyboard 12 and a mouse 13. Those input signals are supplied to the CPU 101 via the bus 107. The communication interface 106 is connected to the administrative network 10, allowing the CPU 101 to exchange data with other computers (not shown) on the administrative network 10.

The above-described computer serves as a hardware platform for realizing the processing functions of the present embodiment. While FIG. 3 illustrates an administration server 100, the same hardware structure may also be applied to other devices, including the clients 21 and 22, servers 31 to 33, and storage devices 51 and 52 shown in FIG. 2. The servers 31 to 33 and storage devices 51 and 52, however, have a plurality of communication interfaces. The storage devices 51 and 52 are each equipped with many HDD units.

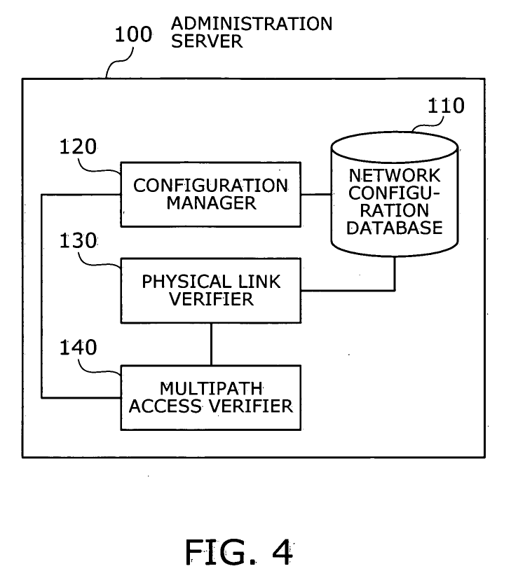

The administration server 100 provides specific processing functions proposed in the present invention. Specifically, FIG. 4 is a block diagram showing functions of the administration server 100. Included in this administration server 100 are a network configuration database 110, a configuration manager 120, a physical link verifier 130, and a multipath access verifier 140.

The network configuration database 110 is used to manage, among others, the information about physical connections between devices constituting a SAN system. This information is called a link list. The configuration manager 120 collects information about the current connections from those devices and stores the collected information in the network configuration database 110. The configuration manager 120 also receives access path data from the servers 31 to 33 and passes it to the multipath access verifier 140.

The physical link verifier 130 verifies redundancy of physical connections, based on a link list stored in the network configuration database 110. Specifically, the physical link verifier 130 identifies the network configuration from the given link list and searches it for routes between a server and a storage device specified by the administrator. Based on the search result, the physical link verifier 130 then determines whether the network has redundancy in its physical links.

The multipath access verifier 140 determines whether each server has redundant access paths, after the redundancy of physical links is verified. Specifically, the multipath access verifier 140 consults the configuration manager 120 to retrieve access path data of each server for comparison with the result of physical link verification. If it turns out that an access path goes along redundant physical links, the multipath access verifier 140 determines that the access paths have good redundancy.

The following sections will provide the details of the configuration manager 120, physical link verifier 130, and multipath access verifier 140.

### Configuration Manager

The configuration manager 120 first analyzes the SAN system and stores data representing the identified system configuration into the network configuration database 110. More specifically, the configuration manager 120 requests each SAN component device to send the identifiers of their own ports. The configuration manager 120 also requests the switches 41 to 43 to send identifiers representing to which ports of remote devices their own ports are physically linked. Based on the received information, the configuration manager 120 stores configuration data of the SAN system in the network configuration database 110.

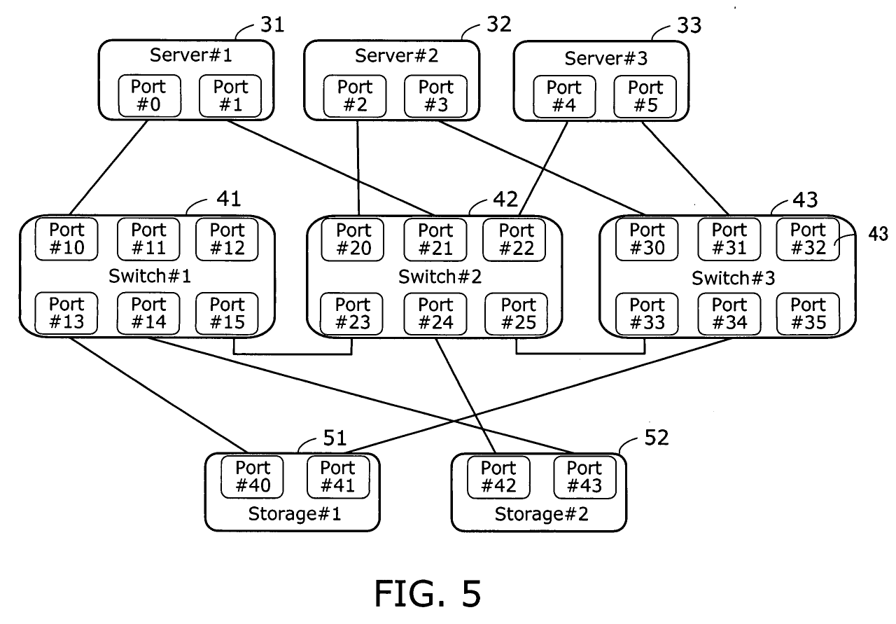

FIG. 5 shows a physical connection model of the SAN system discussed in FIG. 2. As can be seen from this model, every device is assigned a unique identifier that distinguishes each device from others in the SAN system. Specifically, one server 31 is assigned an identifier of “Server#1.” Likewise, the other servers 32 and 33 are assigned “Server#2” and “Server#3,” respectively. The switches 41, 42, and 43 are assigned “Switch#1” “Switch#2,” and “Switch#3,” respectively. The storage devices 51 and 52 are assigned “Storage#1” and “Storage#2,” respectively.

Further, every port on the devices has a unique port number to distinguish that port from others within the same SAN system. Specifically, the server 31 is assigned “Port#0” and “Port#1” as its port identification numbers. Likewise, the server 32 is assigned “Port#2” and “Port#3,” and the server 33 is assigned “Port#4” and “Port#5.”

The switch 41 is assigned “Port#10,” “Port#11,” “Port#12,” Port#13,” “Port#14,” and “Port#15” as its port identification numbers. Likewise, the switch 42 is assigned “Port#20,” “Port#21,” “Port#22,” “Port#23,” “Port#24,” and “Port#25,” and the switch 43 is assigned “Port#30,” “Port#31,” “Port#32,” “Port#33,” “Port#34,” and “Port#35.” The storage device 51 is assigned “Port#40” and “Port#41,” and the storage device 52 is assigned “Port#42” and “Port#43.” Where appropriate, we may use those port identification numbers (or simply “port numbers”) to refer to the ports themselves.

The ports are interconnected by communication cables. Specifically, Port#0 of the server 31 is connected to Port#10 of the switch 41. Port#1 of the server 31 is connected to Port#21 of the switch 42. Port#2 of the server 32 is connected to Port#20 of the switch 42. Port#3 of the server 32 is connected to Port#30 of the switch 43. Port#4 of the server 33 is connected to Port#22 of the switch 42. Port#5 of the server 33 is connected to Port#31 of the switch 43. Port#13 of the switch 41 is, connected to Port#40 of the storage device 51. Port#14 of the switch 41 is connected to Port#43 of the storage device 52. Port#15 of the switch 41 is connected to Port#23 of the switch 42. Port#24 of the switch. 42 is connected to Port#42 of the storage device 52. Port#25 of the switch 42 is connected to Port#33 of the switch 43. Port#34 of the switch 43 is connected to Port#41 of the storage device 51.

From each device, the configuration manager 120 collects information about physical connections shown in FIG. 5. Specifically, the configuration manager 120 obtains a link list (i.e., multiple sets of source and destination port numbers) from the switches 41 to 43, besides receiving port numbers from the servers 31 to 33, switches 41 to 43 and storage devices 51 and 52. Based on the obtained information, the configuration manager 120 then registers the SAN system configuration with the network configuration database 110.

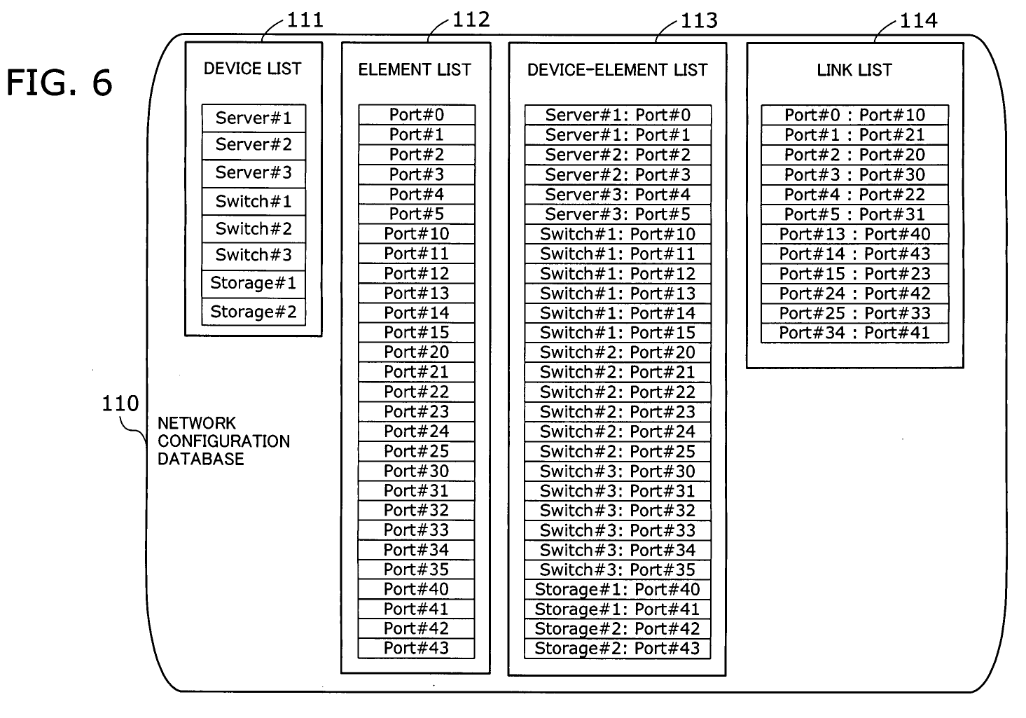

FIG. 6 shows an example data structure of the network configuration database 110. As can be seen from FIG. 6, the configuration manager 120 uses this network configuration database 110 to store a device list 111, an element list 112, a device-element list 113, and a link list 114. The device list 111 is a collection of registered device identifiers. The element list 112 is a collection of registered port numbers. The device-element list 113 is a set of data records that describe the association between devices and their ports (elements). In short, the device-element list 113 indicates which device has what ports. The link list 114 is a set of data records each representing a port-to-port physical link. Those link list records derive from the information obtained from the switches 41 to 43, i.e., the identifiers of remote ports that are physically connected to the switches 41 to 43.

### Physical Link Verifier

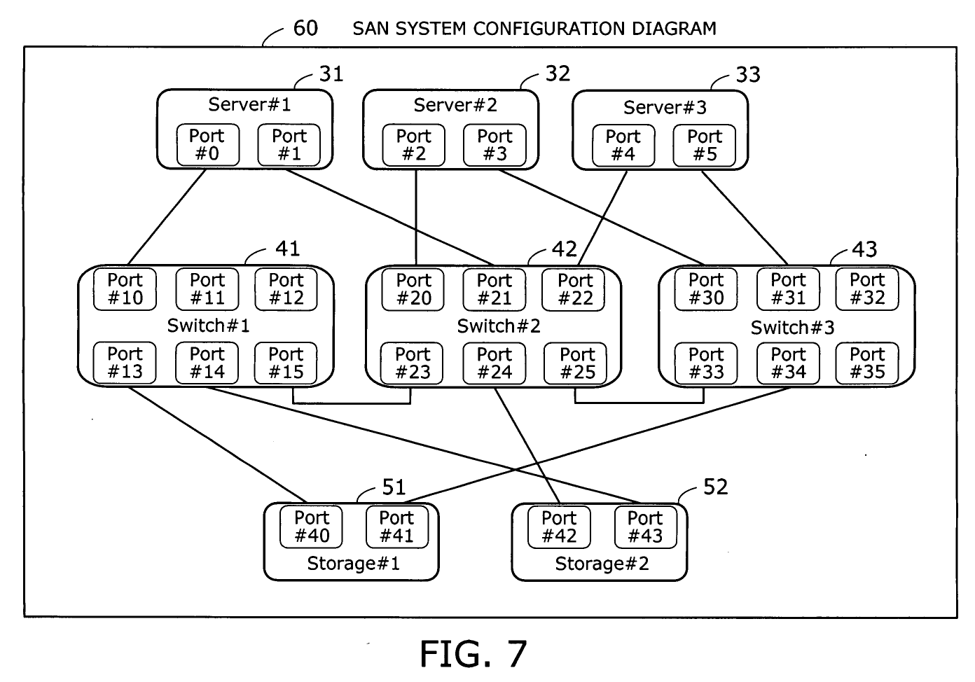

By combining data records in the network configuration database 110, the physical link verifier 130 can identify the actual SAN system configuration. The physical link verifier 130 can also visualize the SAN, configuration on a screen of the monitor 11, as shown in FIG. 7. That is, the physical link verifier 130 draws a SAN system configuration diagram 60 based on the data records stored in the network configuration database 110. The physical link verifier 130 outputs this SAN system configuration diagram 60 when starting a process of physical link verification upon receipt of a user command to do so.

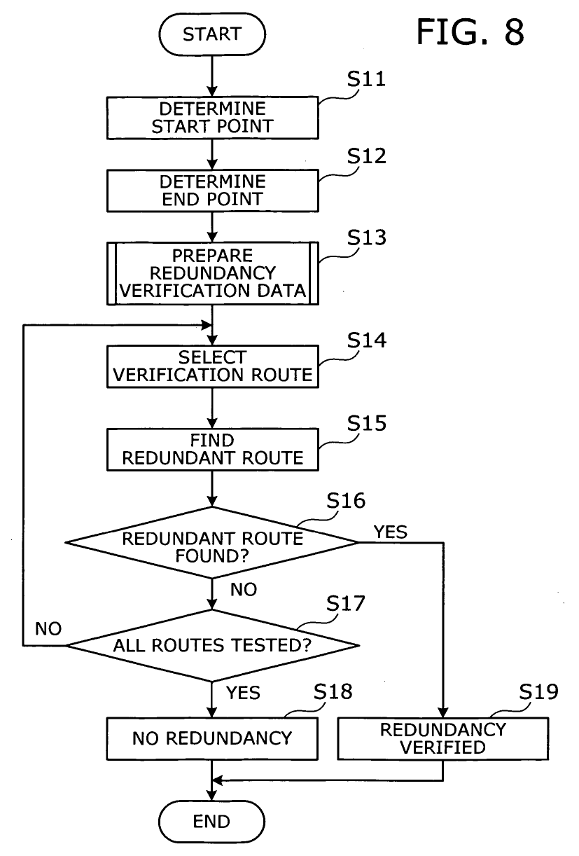

FIG. 8 is a flowchart of a physical link verification process. This process includes the following steps:

(Step S11) The physical link verifier 130 determines a start point. Specifically, the user selects a particular server from among those shown in the SAN system configuration diagram 60, thus permitting the physical link verifier 130 to select that server as a start-point device.

(Step S12) The physical link verifier 130 determines an end point. Specifically, the user selects a particular storage device from among those seen in the SAN system configuration, diagram 60, thus permitting the physical link verifier 130 to select that device as an end-point device.

(Step S13) The physical link verifier 130 prepares redundancy verification data. The details of this process will be discussed later.

(Step S14) The physical link verifier 130 selects a verification route. Specifically, the physical link verifier 130 chooses an untested route from among all possible routes between the start point to the end point that are specified. This selected route is referred to as the “verification route.”

(Step S15) The physical link verifier 130 attempts to find a redundant route corresponding to the selected verification route. Specifically, to find a route from start point to end point, the physical link verifier 130 searches the physical link list, excluding devices and links on the verification route. If a route is found, that route is recorded to as a redundant route.

(Step S16) The physical link verifier 130 determines whether any redundant route is found at step S15. If so, the process advances to step S19. If not, the process proceeds to step S17.

(Step S17) The physical link verifier 130 determines whether there is any untested route between the given start and end points. If all routes have been tested, then the process advances to step S18. If there is an untested route, the process goes back to step S14.

(Step S18) Now that all possible routes are examined without success, the physical link verifier 130 concludes that the SAN system lacks redundancy in its physical linkst, thus exiting from this process.

(Step S19) Now that there is at least one pair of independent routes between the selected start and end points, the physical link verifier 130 concludes that the SAN system has redundancy in its physical links, thus exiting from this process.

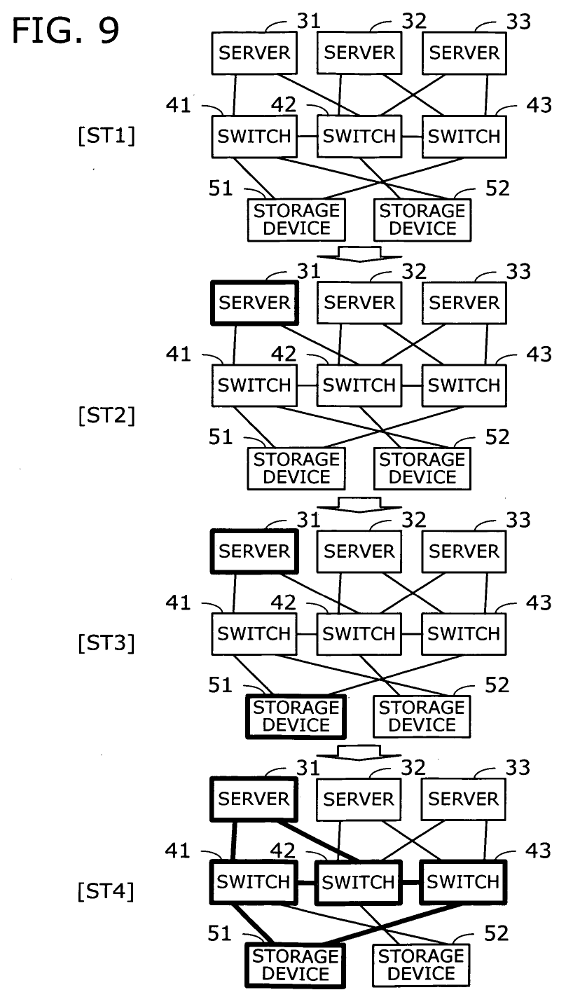

In the way described in FIG. 8, the physical link verifier 130 determines the redundancy of physical links. This verification process will now be illustrated schematically, with reference to FIG. 9.

FIG. 9 shows a process of data analysis according to a related configuration extraction procedure, which includes the following four stages. At the first stage ST1, the physical link verifier 130 recognizes the configuration of a network system to be verified. A particular server is to be selected as a start point in this stage according to a user command or the like. In, the second stage ST2, the selected start-point device (server 31 in the present example) is highlighted. The third stage ST3 permits an end-point device (e.g., storage device 51) to be selected according to a user command or the like.

In the fourth stage ST4, now that both the start and ends points are selected, the physical link verifier 130 extracts all elements (devices and links) related to communication between the selected start and end points. Highlighted are the server 31, switches 41 to 43, storage device 51, and links between them. The physical link verifier 130 compiles redundancy verification data including those related elements.

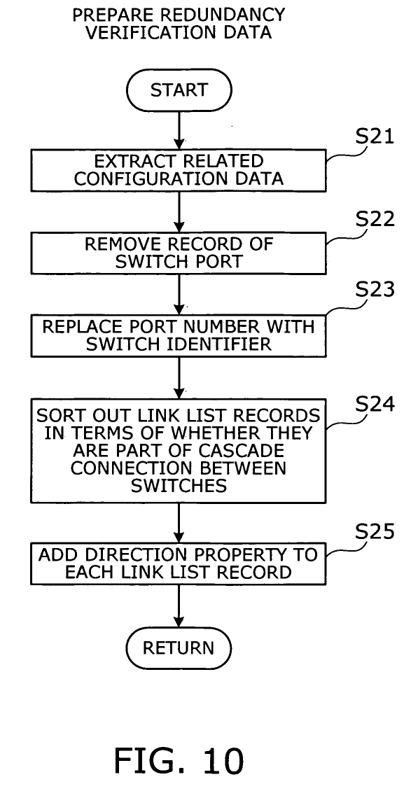

FIG. 10 is a flowchart of a process of preparing redundancy verification data. This process includes the following steps:

(Step S21) From a given SAN system configuration, the physical link verifier 130 extracts elements related to communication between the specified start and end points. Specifically, the physical link verifier 130 consults the network configuration database 110 to extract its data records other than those unrelated to the: start and end points. The resulting set of data records are then stored as “related configuration data” in the RAM 102 (see FIG. 3).

(Step S22) The physical link verifier 130 removes data records describing ports of switches from the related configuration data. Since the redundancy of physical links has nothing to do with which port on a switch is actually used, removing such information from the data will do no harm to the verification. Rather, it contributes to more efficient verification.

(Step S23) Switch port numbers are also included in some records of the link list in the related configuration data. The physical link verifier 130 thus replaces those switch port numbers with the identifiers of their corresponding switches.

(Step S24) The physical link verifier 130 sorts out the link list records in terms of whether they are part of a cascade connection between switches.

(Step S25) For each link list record, the physical link verifier 130 gives an additional property that indicates the direction from access source to access destination. More specifically, a bidirectional property is set to every cascading link between switches. For the links between servers and switches, a unidirectional property from server to switch is given. Further, a unidirectional property from switch to storage is given to the links connecting switches with storage devices.

The above steps create redundancy verification data. In this process, the physical link verifier 130 recognizes various data as will be described in detail below.

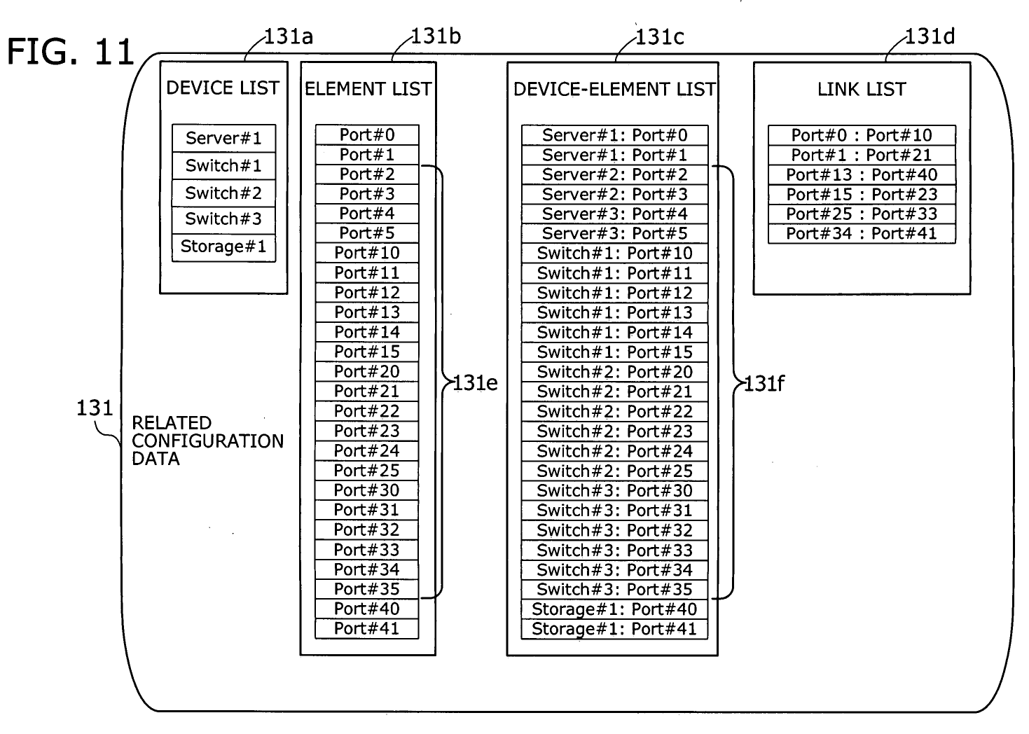

FIGS. 11 shows an example data structure of related configuration data. This related configuration data 131 includes a device list 131a, an element list 131b, a device-element list 131c, and a link list 131d. The device list 131a is a collection of device identifiers indicating which devices are related to the start and end points. The element list 131b is a collection of registered port numbers of the related devices. The device-element list 131c is a collection of data records giving the associations between related devices and their ports (elements). The link list 131d is a set of data records representing port-to-port physical links.

The related configuration data 131 of FIG. 11 is derived from the network configuration database 110 of FIG. 6 by removing records about irrelevant devices (Server#2, Server#3, Storage#2 in this case) that are not involved in the communication between given start and end points (Server#1 and Storage#1). Step S22 of FIG. 10 further removes some unnecessary switch-related records from the related configuration data 131. What are removed in the present example are: port numbers 131e in the element list 131b, and data records 131f in the device-element list 131c. Also, steps S23 to S25 of FIG. 10 give direction properties to the link list 131d. The resulting version of system configuration data is now stored in the RAM 102 as redundancy verification data.

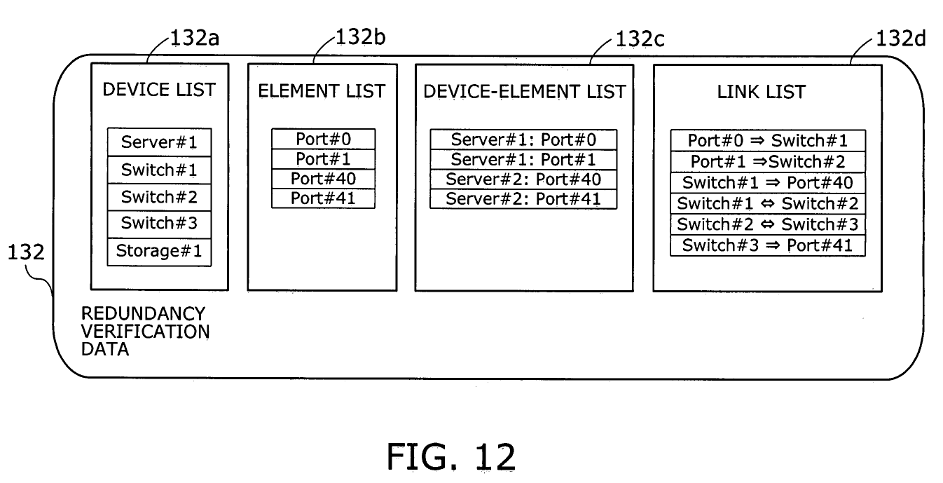

FIG. 12 shows an example data structure of such redundancy verification data. The illustrated redundancy verification data 132 includes a device list 132a, an element list 132b, a device-element list 132c, and a link list 132d. The device list 132a is exactly the same as the device list 131a in the related configuration data 131 of FIG. 11. The element list 132b is what remains after the switch port numbers 131e have been removed from the original element list 131b in the related configuration data 131. The device-element list 132c is what remains after the switch-related records 131f have been removed from the original device-element list 131c in the related configuration data 131. The link list 132d derives from the link list 131d in the related configuration data 131. Notice that the port numbers of switches have been replaced with the identifiers of those switches, and that each record has a direction property (represented by unidirectional and bidirectional arrows in FIG. 12).

As can be seen from FIGS. 11 and 12, the present embodiment performs data reduction on the system configuration data before starting verification. As mentioned earlier, the redundancy of server-to-storage physical links is determined by testing whether one physical path shares the same switch with another path, and this test requires no port number information concerning the switches. Those unnecessary switch port numbers are therefore removed to accelerate the verification processing.

In addition, the link list records containing switch port numbers associated with server ports or storage device ports are converted to logical link records that associate switch port numbers with switch identifiers.

Direction properties of link list records permit the physical link verifier 130 to trace the links in particular directions depending on the arrangement of devices. Specifically, it is allowed to go from a server to a switch, or from a switch to a storage device, but not from a switch to a server, nor from a storage device to a switch. Links between switches, on the other hand, are given a bidirectional property.

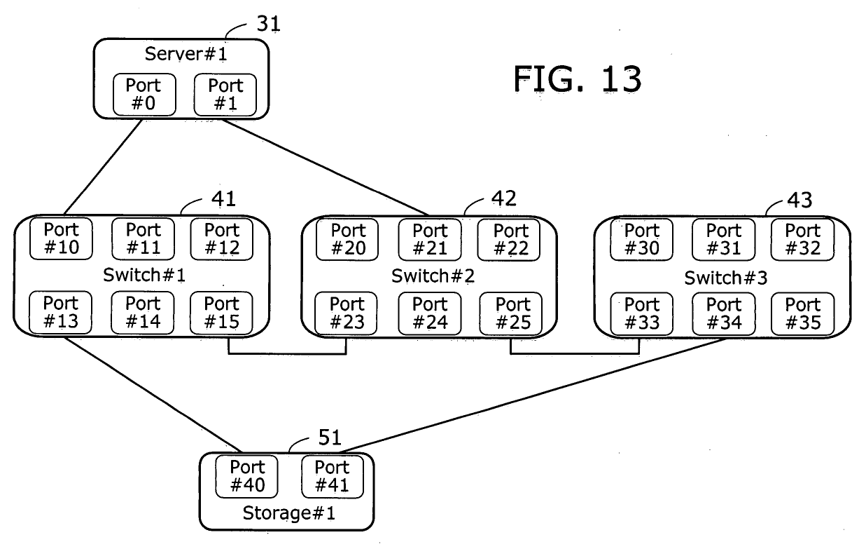

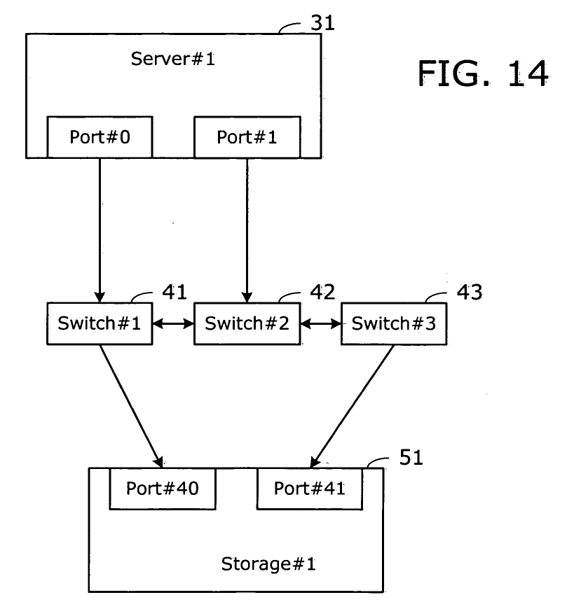

With unnecessary data eliminated, the physical link verifier 130 can process redundancy verification data quickly to determine whether the network has redundancy. Referring now to FIGS. 13 and 14, the following section will discuss how the physical link verifier 130 views the SAN system configuration with the related configuration data 131 and redundancy verification data 132.

FIG. 13 shows a SAN system representation based on the related configuration data 131 of FIG. 11. In comparison with FIG. 5, the servers 32 and 33, storage device 52, and their links are all eliminated in the model of FIG. 13. FIG. 14 shows a SAN system representation based on the redundancy verification data 132 of FIG. 12. The system model is further simplified; i.e., there are no port numbers indicated in the switches 41 to 43. It should also be noted that every link between devices is represented by a unidirectional or bidirectional arrow. The physical link verifier 130 searches this redundancy verifications data 132 to find a verification route as follows.

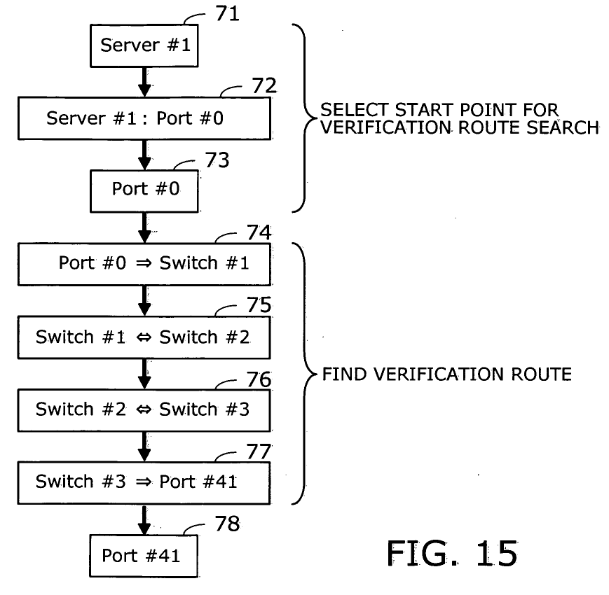

FIG. 15 shows how to find a route on the given redundancy verification data 132. The physical link verifier 130 first searches the device list 132a to find the start-point server 31, thus obtaining a data record 71 containing its identifier “Server#1.” The physical link verifier 130 now consults the device-element list 132c to find a port number associated with the identifier “Server#1.” This search may yield multiple hits (two in the present example), in which case the physical link verifier 130 selects one of them. Based on the selected data record 72, the physical link verifier 130 then extracts a port number 73 with a value of “Port#0”. In this way, the start point port is determined for use in the subsequent verification route search.

Now that the start point is selected, the physical link verifier 130 then searches the link list 132d for a data record 74 that describes a link extending from the start point port. In the example of FIG. 15, the data record 74 indicates that the link reaches a switch designated as “Switch#1.” The physical link verifier 130 consults the link list 132d again, thus obtaining a data record 75 of a next physical link extending from the switch “Switch#1.” In the example of FIG. 15, the data record 75 indicates that the link reaches another switch designated as. “Switch#2.” The physical link verifier 130 consults the link list 132d again, thus obtaining a data record 76 of a next physical link extending from Switch#2. This data record 76 indicates that the link reaches yet another switch designated as “Switch#3.” The physical link verifier 130 consults the link list 132d again, thus obtaining a, data record 77 of a next physical link extending from Switch#3.

In searching the link list 132d, the physical link verifier 130 pays attention to the link direction defined in each record, so that it can selectively examines the source side of each record in the case that a unidirectional property is given. When a relevant record is found, the physical link verifier 130 marks that record as “finished” so as to exclude it from the scope of further searches, thereby preventing the route from mistakenly turning back to the same place.

Referring back to FIG. 15, the data record 77 indicates that the destination of that link is Port#41 of the storage device 51. The physical link verifier 130 extracts a data record 78 with a value of “Port#41” from the element list 132b, thus successfully finding a verification route.

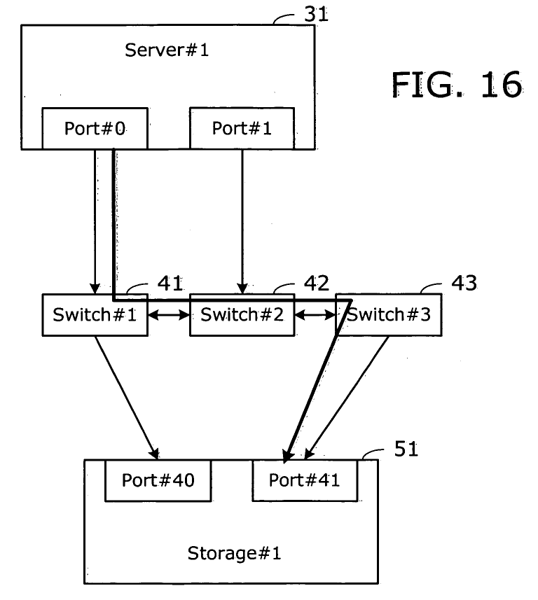

FIG. 16 shows the verification route found in the above process. In the present example, the verification route starts at Port#0 of the server 31 and goes through three switches 41, 42, and 43 in that order, before reaching Port#41 of the storage device 51.

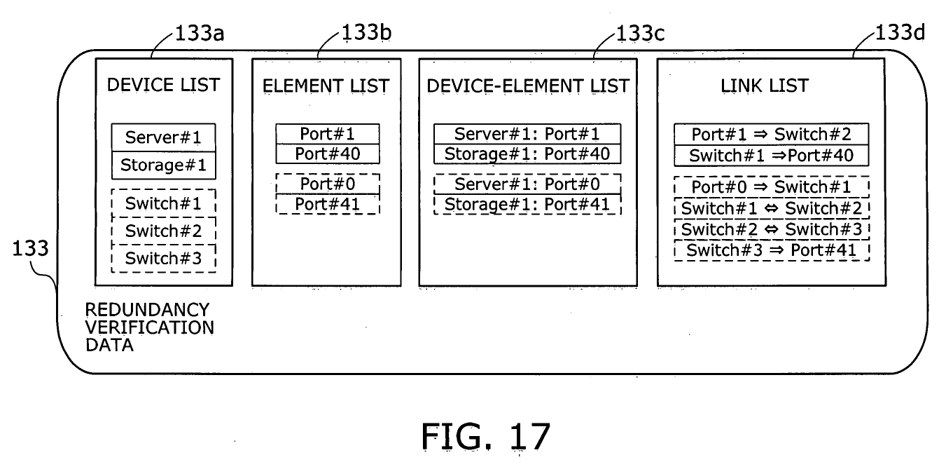

With the verification route determined, the physical link verifier 130 searches for a corresponding redundant route. Before starting this search, the physical link verifier 130 removes the data records of devices and links on the verification route from the redundancy verification data 132. FIG. 17 shows the resulting redundancy verification data 133, in which the broken-line boxes represent removed data records for explanatory purposes.

The redundancy verification data 133 includes a device list 133a, an element list 133b, a device-element list 133c, and a link list 133d. The device list 133a contains only “Server#1” and “Storage#1,” the identifiers of the server 31 and storage device 51, while the other data records are deleted. The element list 133b contains only data records of “Port#1” and “Port#40” unrelated to the verification route, while eliminating the others. The device-element list 133c contains only data records describing device-port relationships unrelated to the verification route, while eliminating the others. The link list 133d contains only data records of physical links unrelated to the verification route, while eliminating the others.

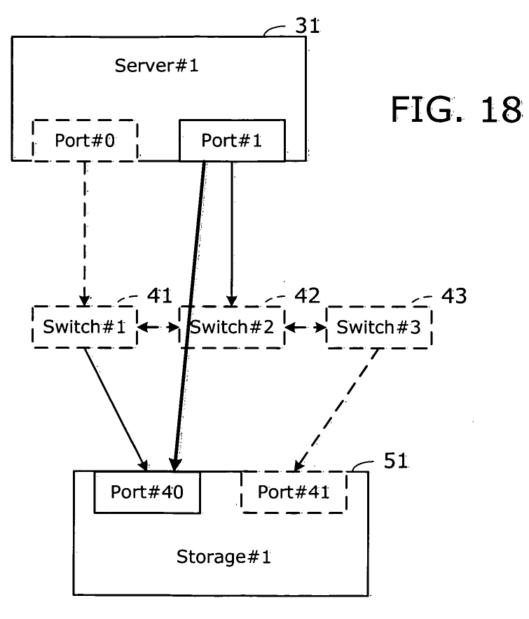

The redundancy verification data 133 modified as such is searched by the physical link verifier 130 to find a redundant route, i.e., a route that starts at an unrelated port of the server 31 and reaches an unrelated port of the storage device 51. FIG. 18 shows a logical process of finding a redundant route. The broken lines indicate which devices and physical links are excluded as being involved in the verification route, and the physical link verifier 130 is only allowed to search the remaining SAN components in finding a route from Port#1 to Port#40 indicated by the bold line in FIG. 18.

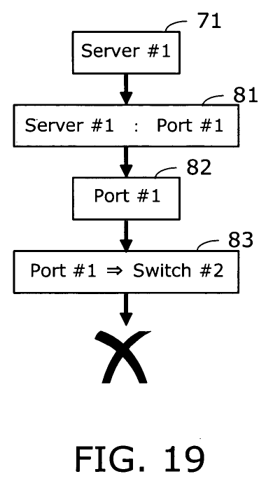

Based on the reduced redundancy verification data 133, the physical link verifier 130 tries to find a redundant route from Port#1 to Port#40. FIG. 19 depicts how the physical link verifier 130 executes this task. The physical link verifier 130 first examines the device list 133a to find the start-point server 31, thus obtaining a data record 71 containing its identifier “Server#1.” The physical link verifier 130 then consults the device-element list 133c to find a port number associated with that identifier “Server#1.” This search yields a data record 81 containing “Server#1: Port#1.” Based on this data record 81, the physical link verifier 130 extracts a port number 82 with a value of “Port#1”. In this way, the physical link verifier 130 identifies the start point port, from which the subsequent redundant route search begins.

Subsequently the physical link verifier 130 searches the link list 133d and finds a data record 83 that describes a link extending from the start-point port. In the example of FIG. 19, the data record 83 indicates that the link reaches yet another switch designated as “Switch#2.” Accordingly, the physical link verifier 130 consults the link list 133d again in an attempt to obtain a data record of a physical link wired from Switch#2. The link list 133dc, however, contains no such data record. The physical link verifier 130 thus concludes that there is no redundant route corresponding to the verification route.

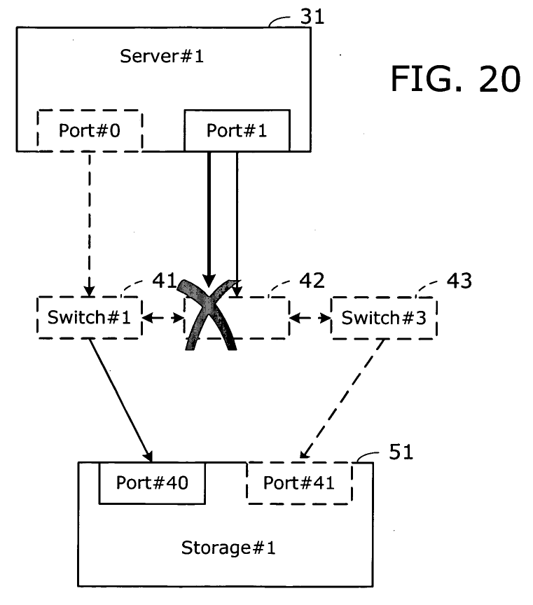

FIG. 20 depicts the unsuccessful result of redundant route search. The search has failed because the switch 42 is right on the verification route. Since no redundant route exists, the physical link verifier 130 goes back to an earlier stage in an attempt to find a different verification route, other than the one that was selected as a verification route.

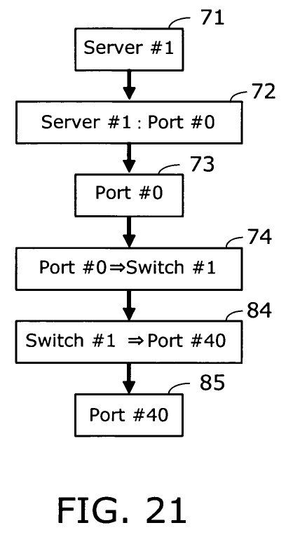

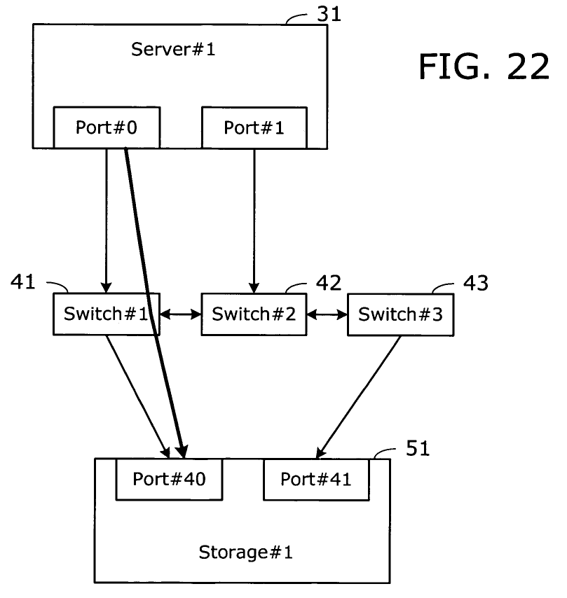

FIG. 21 shows how to find another verification route on redundancy verification data. This second attempt proceeds in the same way as in FIG. 15 until it obtains a data record 74. The physical link verifier 130 searches the link list 132d and finds a data record 84 that describes a link extending from Switch#1. In the example of FIG. 21, the data record 84 contains a destination port identifier “Port#40” of the end-point storage device 51. The physical link verifier 130 now looks into the element list 132b and retrieves a data record 85 for the port “Port#40,” thus successfully finding a second verification route. FIG. 22 shows this verification route found in the second search. Specifically, the newly found verification route starts at Port#0 of the server 31 and reaches Port#40 of the storage device 51 via the switch 41.

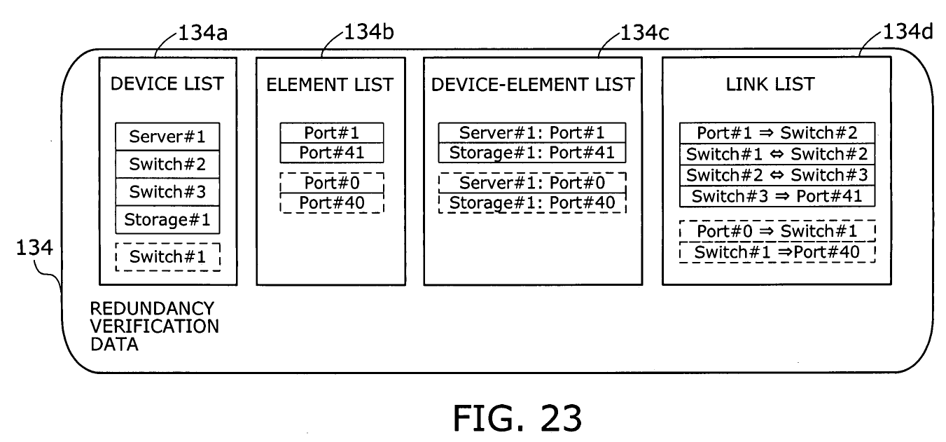

With the verification route determined, the physical link verifier 130 searches for a corresponding redundant route. Before starting this search, the physical link verifier 130 removes the data records of devices and links on the verification route from a reduced version of the redundancy verification data 132. FIG. 23 shows the resulting redundancy verification data 134, in which the broken-line boxes represent removed data records. Specifically, the device list 134a provides no record for the switch 41 (Switch#1) since it is deleted as being relevant to the verification route. The element list 134b only contains data records of “Port#1” and “Port#41” unrelated to the verification route, while eliminating the others. The device-element list 134c contains only two data records describing device-port relationships unrelated to the verification route, while eliminating the others. The link list 134d only contains unrelated physical links, while eliminating the others. Actually, the link list 134d excludes two physical links, one from Port#0 to Switch#1 and the other from Switch#1 to Port#40.

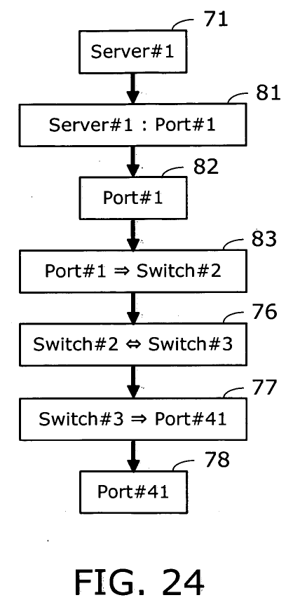

From among the data records in the redundancy verification data 134 modified as such, the physical link verifier 130 successfully finds a redundant route, i.e., a route that starts at an unrelated port of the server 31 and reaches an unrelated port of the storage device 51. FIG. 24 shows a process of finding a redundant route. The physical link verifier 130 first searches the device list 134a for the specified start-point server 31, thus obtaining a data record 71 containing its identifier “Server#1.” The physical link verifier 130 then consults the device-element list 134c to find a port number associated with that identifier “Server#1.” This search yields a data record 81 containing “Server#1: Port#1.” Based on this data record 81, the physical link verifier 130 extracts a port number 82 with a value of “Port#1”. In this way, the physical link verifier 130 identifies the start point port, from which the subsequent redundant route search begins.

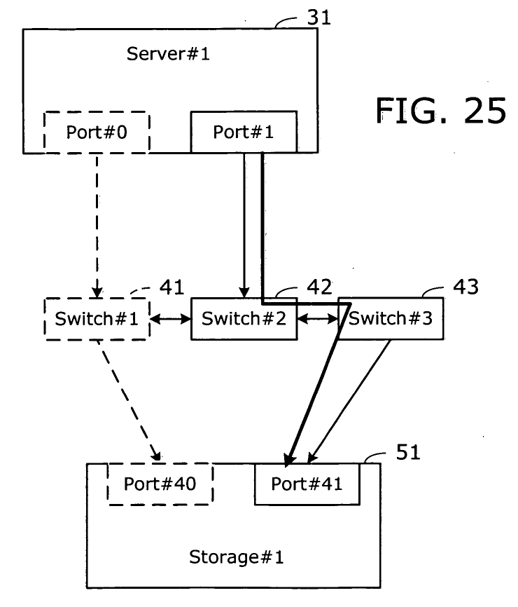

Subsequently the physical link verifier 130 searches the link list 134d to find a data record 83 that describes a link extending from the start-point port. In the example of FIG. 24, the data record 83 indicates that the link reaches another switch designated as “Switch#2.” The physical link verifier 130 consults the link list 134d again, thus obtaining a data record 76 of a next physical link extending from Switch#2. Since this data record 76 indicates that the link goes to yet another switch “Switch#3,” the physical link verifier 130 consults the link list 134d again to retrieve a data record 77 of a next physical link extending from Switch#3. In the example of FIG. 24, the retrieved data record 77 indicates that the destination of that link is Port#41 of the storage device 51. The physical link verifier 130 now looks into the element list 134b and retrieves a data record 78 with a value of “Port#41,” thus successfully finding a redundant route. FIG. 25 shows the redundant route that is found, which starts at Port#1 of the server 31 and goes through the switches 42 and 43 before reaching Port#41 of the storage device 51.

### Multipath Access Verifier

The physical link verifier 130 verifies redundancy of physical links through the above-described process. In the present example, dual redundant routes are found between the server 31 and the storage device 51. One path starts at Port#0 of the server 31, goes through the switch 41, and reaches Port#40 of the storage device 51. The other path starts at Port#1 of the server 31, goes through the switches 42 and 43, and reaches Port#41 of the storage device 51. The physical link verifier 130 passes the information on those redundant routes to the multipath access verifier 140. The multipath access verifier 140 then retrieves multipath access information of the server 31 from the configuration manager 120 in order to compare it with the redundant routes that are found.

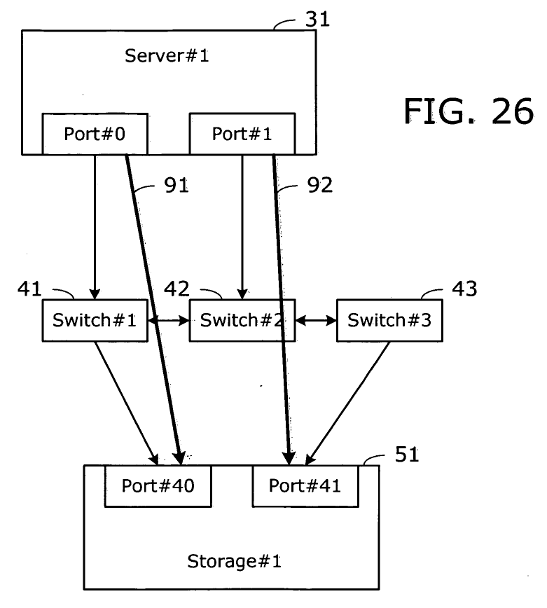

FIG. 26 shows a first example of multipath access. This example gives two access paths. A first access path 91 is set from Port#0 of the server 31 to Port#40 of the storage device 51. A second access path 92 is set from Port#1 of the server 31 to Port#41 of the storage device 51. The multipath access verifier 140 compares these access paths with the routes found by the physical link verifier 130. This comparison reveals the presence of a pair of physical routes (i.e., a verification route and a redundant route) corresponding to the access paths of interest, thus proving that the redundancy of multipath access is established in the present example.

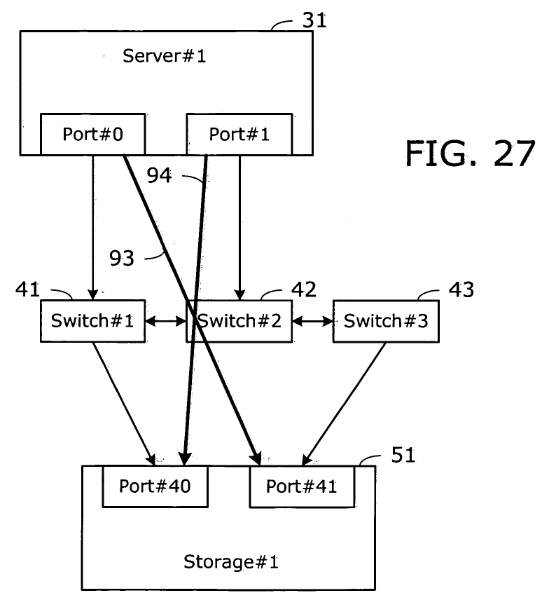

FIG. 27 shows a second example of multipath access. This example has a first access path 93 from Port#0 of the server 31 to Port#41 of the storage device 51. It also has a second access path 94 from Port#1 of the server 31 to Port#40 of the storage device 51. The multipath access verifier 140 compares these access paths with the routes found by the physical link verifier 130. The comparison reveals the lack of physical routes corresponding to the access paths of interest, meaning that no redundancy is provided in multipath access. In this case, the multipath access verifier 140 outputs a warning message on a monitor screen to indicate the lack of redundancy. Optionally, the multipath access verifier 140 may be configured to suggest an alternative setup of redundant routes.

The proposed administration server 100 finds an appropriate set of routes for redundant multipath access in a SAN environment, based on the information about physical links between servers and storage devices. For existing multipath access routes, it can test whether they are correctly mapped on redundant physical links.

### Redundancy Level Evaluation

While the foregoing examples determine the redundancy in terms of whether there are a plurality of physical links for a single logical connection, it is also possible to provide a physical link verifier 130 that tests all possible routes and counts how many redundant routes exists.

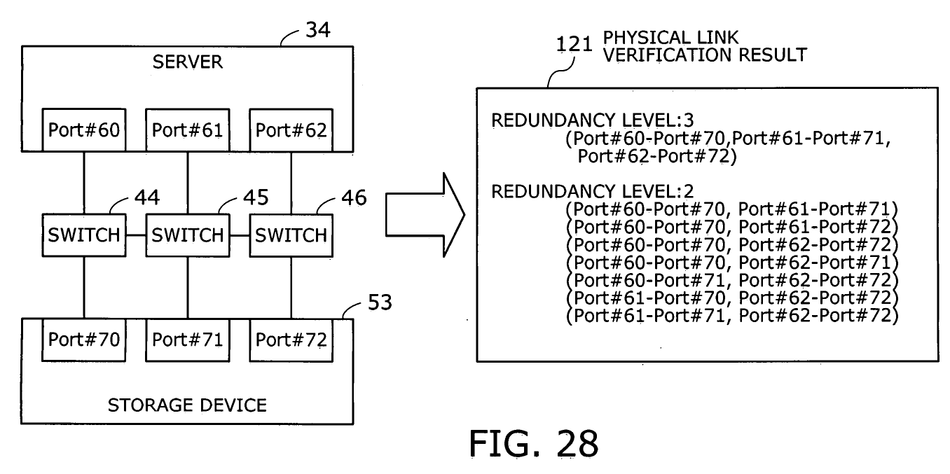

FIG. 28 shows an example result of a physical link verification performed for determining a redundancy level. This physical link verification result 121 assumes a SAN system formed from a server 34, three switches 44 to 46, and a storage device 53 as shown in the left half of FIG. 28. The server 34 has three ports designated as “Port#60,” “Port#61,” and “Port#62”. Port#60 of this server 34 is linked to the switch 44. Likewise, Port#61 and Port#62 are linked to the switches 45 and 46, respectively. The switches 44 and 45 are linked to each other, as are the switches 45 and 46. The storage device 53 has three ports designated as “Port#70,” “Port#71,” and “Port#72”. Port#70 of this storage device 53 is linked to the switch 44. Port#71 and Port#72 are linked to different switches 45 and 46, respectively.

The physical link verifier 130 evaluates the above SAN system, particularly the redundancy in physical links from the server 34 to the storage device 53. The outcomes of this evaluation, including redundancy levels, are made available as physical link verification result 121. The physical link verification result 121 shown in FIG. 28 includes, two groups of routes, one with a redundancy level of three and the other with a redundancy level of two. Specifically, the former group includes the following three routes: Port#60 to Port#70, Port#61 to Port#71, and Port#62 to Port#72. These routes can be an alternative to each other, and hence the redundancy level of three. The latter group actually consists of seven pairs of routes. Each pair can be used in place of each other, and hence the redundancy level of two.

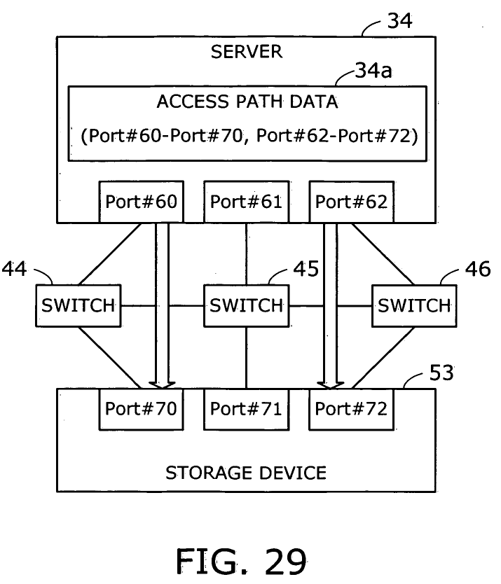

The multipath access verifier 140 receives the above physical link verification result 121 and determines therefrom the redundancy of access paths. FIG. 29 shows an example of dual redundant access paths. This example assumes that the server 34 is configured with access path data 34a describing two independent access paths between the server 34 and storage device 53. One path is set up between Port#60 and Port#70, while the other path is set up between Port#62 and Port#72.

The multipath access verifier 140 compares the access path data 34a with the physical link verification result 121. This comparison reveals that the physical link verification result 121 contains a group of routes that can map onto the present access paths. Accordingly, the multipath access verifier 140 concludes that the server 34 has good redundancy in its access paths to the storage device 53.

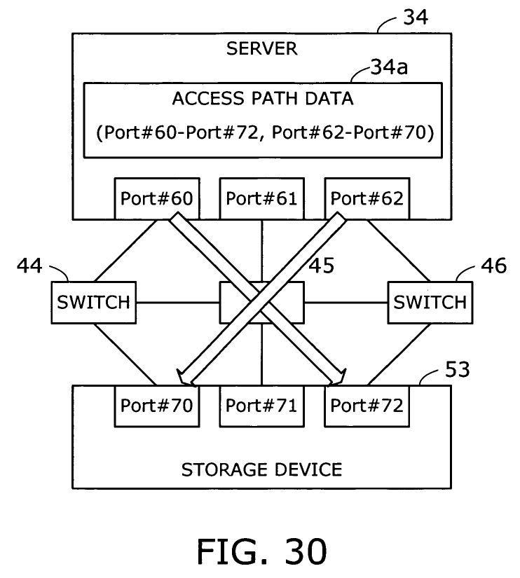

FIG. 30 shows an example of access paths with poor redundancy. This example assumes that the server 34 is configured with access path data 34b describing two access paths between the server 34: and storage device 53. Unlike those shown in FIG. 29, one path is set up between Port#60 and Port#72, and the other path is set up between Port#62 and Port#70.

The multipath access verifier 140 compares the access path data 34b with the physical link verification result 121. This comparison reveals that the physical link verification result 121 contains no group of routes that could map onto the present access paths. Accordingly, the multipath access verifier 140 concludes that the server 34 fails to provide redundancy in its access paths to the storage device 53.

In such cases, the multipath access verifier 140 may suggest a new setup for establishing redundant access paths. For example, the multipath access verifier 140 may output the physical link verification result 121 of FIG. 28 on a monitor screen, thus recommending that the access paths be redefined by using some of the redundant routes shown in the physical link verification result 121. This recommendation gives alternative access paths that can be established logically (i.e., without the need for changing physical link connections).

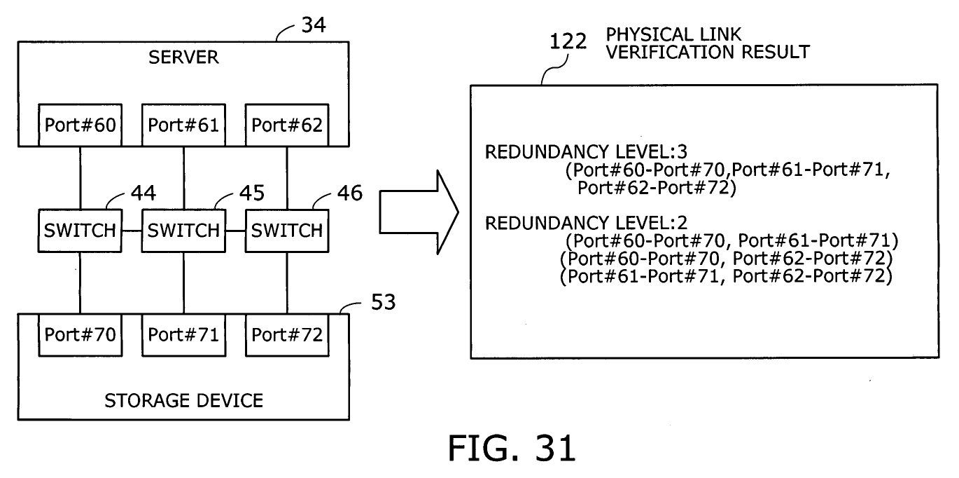

The physical link verifier 130 may optionally extract groups of redundant routes with the shortest length when compiling a physical link verification result. FIG. 31 shows an example; result of a of physical link verification according to this shortest-length method. The illustrated physical link verification result 122 is actually a subset of the physical link verification result 121 of FIG. 28. Notice that it excludes the routes that involve switch-to-switch links. Routes are qualified as shortest routes when, for example, they reach the destination via a minimum number of intermediate devices. More specifically, a redundant group consists of two or more individual routes, each of which may pass a different number of intermediate switches. The physical link verifier 130 therefore adds up those numbers for each group and then chooses the groups that exhibit the smallest sum.

The multipath access verifier 140 may optionally provide the physical link verification result 122 of FIG. 31 as a suggestion for alternative access paths in the case the SAN system in question lacks redundancy in its current access paths. Since only a qualified set of routes are presented, the user can easily choose appropriate access paths with the shortest lengths.

### Redundant SAN Systems

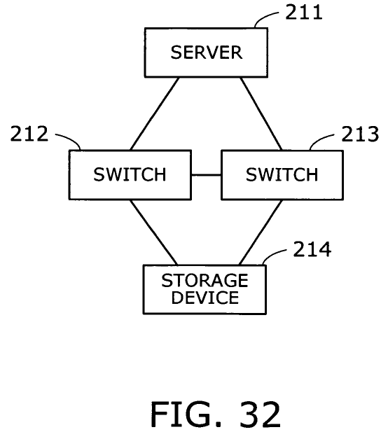

The SAN system configuration discussed earlier in FIG. 2 is only an example for illustrative purposes. Actually the administration server 100 of the present embodiment can work with various topologies of SAN architectures. Referring now to FIGS. 32 to 37, this section will present several example SAN systems that provide redundancy in their physical link.

FIG. 32 shows an example of a SAN system with two switches. This example system has two switches 212 and 213 linked to each other. The system also has a server 211 and a storage device 214, which are bother linked to those two switches 212 and 213 individually.

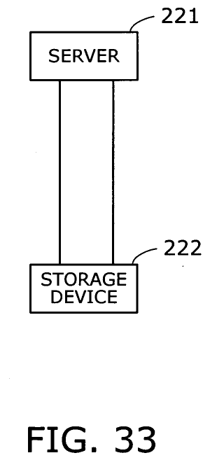

FIG. 33 shows an example of a SAN system with direct server-storage connections. This example system contains one server 221 and one storage device 222. Both the server 221 and storage device 222 have two ports to connect with each other through two direct links.

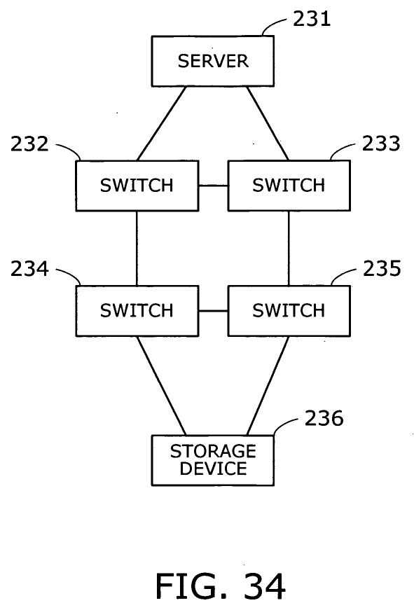

FIG. 34 shows an example of a SAN system with switches connected in a ring topology. In this example, four switches 232, 233, 234, and 235 are circularly connected in that order, thus forming a ring topology. A server 231 is linked to two switches 232 and 233. A storage device 236 is linked to the other two switches 234 and 235.

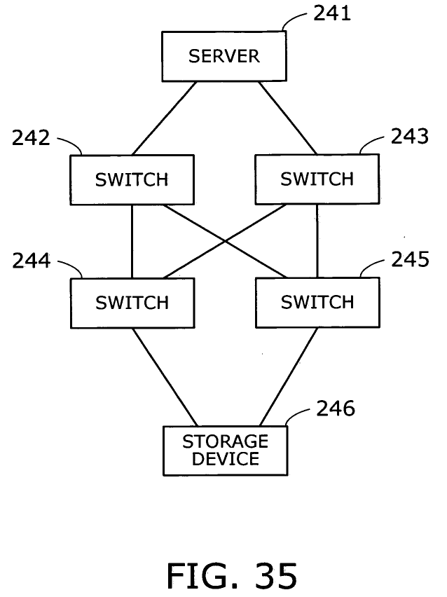

FIG. 35 shows an example of a SAN system with switches connected in a partial mesh topology. This example system employs a partial mesh network of four switches 242, 243, 244, and 245. That is, two switches 242 and 243 are fully linked to the other two switches 244 and 245, whereas there is no direct interconnection between the former switches 242 and 243, nor between the latter switches 244 and 243. A server 241 has two ports to link to the switches 242 and 243. Also, a storage device 246 has two ports to link to the switches 244 and 245.

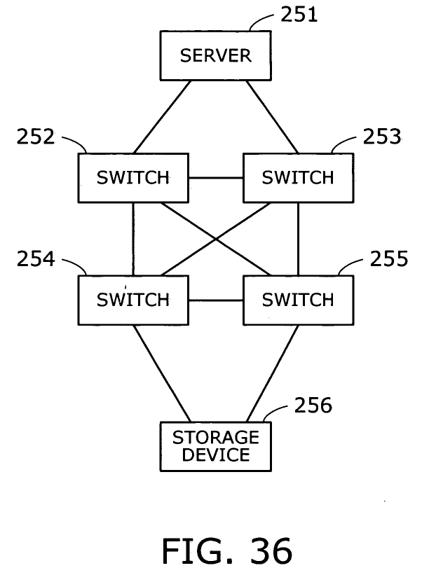

FIG. 36 shows an example of a SAN system with switches connected in a full mesh topology. This example system employs a full mesh network of four switches 252, 253, 254, and 255. That is, all those switches 252 to 255 are linked to each other. A server 251 has two ports to link to the switches 252 and 253. Also, a storage device 256 has two ports to link to the switches 254 and 255.

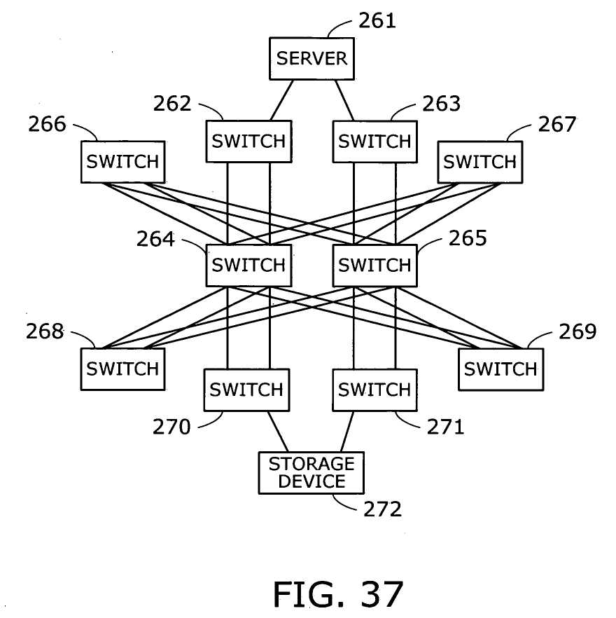

FIG. 37 shows an example SAN system configured in a core/edge topology with multiple core switches. In this example system, a server 261 is linked to two switches 262 and 263. Two physical links extend from the switch 262 to a switch 264. Another two physical links extend from the switch 263 to a switch 265. The switch 264 is coupled to other switches 266, 267, 268, 269, 270, and 271, each through dual physical links. Similarly, the switch 265 is coupled to other switches 266, 267, 268, 269, 270, and 271, each through dual physical links. The switches 270 and 271 are linked to a storage device 272 individually.

All the SAN systems shown in FIGS. 32 to 37 have redundancy in their server-storage physical links. Those systems will therefore pass the redundancy verification test according to the present embodiment. In the case where servers fail to provide redundancy in their access path setups, the multipath access verifier 140 offers a suggestion on how to fix them.

### Non-Redundant SAN Systems

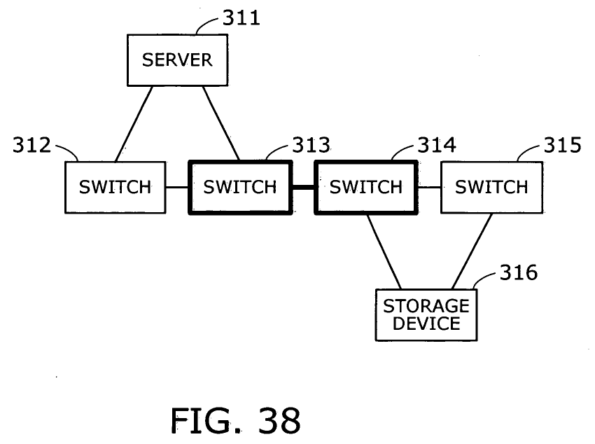

Referring now to FIGS. 38 to 41, this section will present several SAN systems that fail to provide redundancy in their physical link.

FIG. 38 shows an example of a SAN system where multiple redundant routes pass through the same set of cascaded switches. In this example system, four switches 312, 313, 314, and 315 are connected serially in that order. A server 311 is linked to two switches 312 and 313, and a storage device 316 is linked to the other two switches 314 and 315. It has to be noted that the server 311 is unable to establish a communication path to the storage device 316 without passing the same pair of cascaded switches 313 and 314. This means that the system configuration of FIG. 38 lacks redundancy.

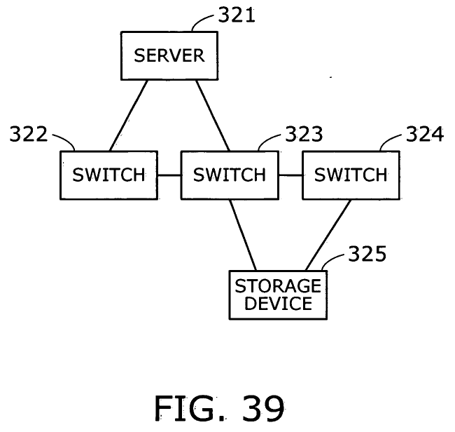

FIG. 39 shows another example of a SAN system, where multiple redundant routes pass through the same switch. This system has three switches 322, 323, and 324 connected in series. A server 321 is linked to the first and second switches 322 and 323, while a storage device 325 is linked to the second and third switches 323 and 324. Notice that the server 321 cannot communicate with the storage device 325 without passing the second switch 323. This means that the system configuration of FIG. 39 lacks redundancy.

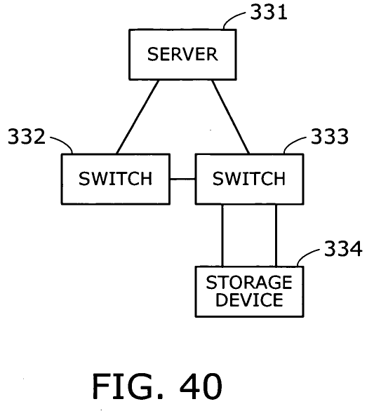

FIG. 40 shows yet another example of a SAN system, where a storage device is connected only to one switch. Specifically, this system has two switches 332 and 333. A server 331 is linked to both switches 332 and 333, whereas two ports of a storage device 334 are both connected to the same switch 333. The problem is that the server 331 cannot communicate with the storage device 334 without passing the switch 333. This means that the system configuration of FIG. 40 lacks redundancy.

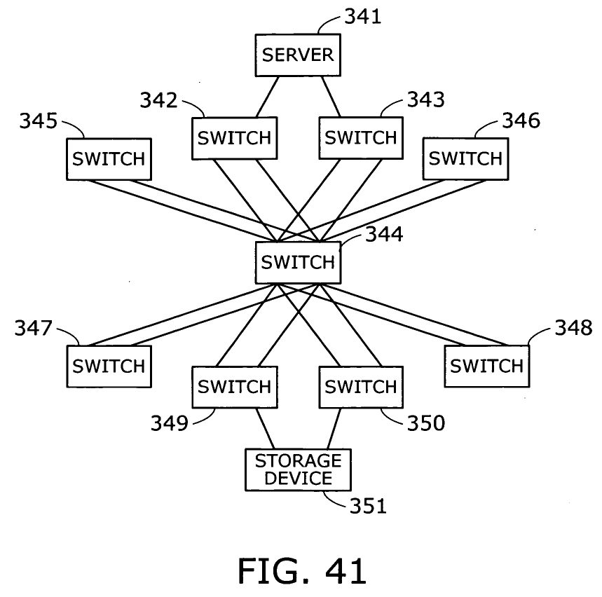

FIG. 41 shows an example SAN system configured in a core/edge topology with a single core switch. In this example system, a server 341 is linked to two switches 342 and 343. Two physical links run from the switch 342 to a core switch 344. Another two physical links extend from the switch 343 to the core switch 344. The switch 344 is coupled to other switches 345, 346, 347, 348, 349, and 350, each through dual physical links. The switches 349 and 350 are linked to a storage device 351 individually. Notice that the server 341 cannot communicate with the storage device 351 without passing the single core switch 344. This means that the system configuration of FIG. 41 lacks redundancy.

As can be seen from FIG. 38 to FIG. 41, all the illustrated SAN systems lack the redundancy in their physical links. They will therefore fail the redundancy verification test according to the present embodiment.

### Program Storage Media

The above-described processing mechanisms of the administration server are actually implemented on a computer system, the instructions being encoded and provided in the form of computer programs. The computer system executes those programs to provide the intended server functions of the present invention. For the purpose of storage and distribution, the programs are stored in computer-readable storage media, which include magnetic storage media, optical discs, magneto-optical storage media, and solid state memory devices. Magnetic storage media include hard disk drives (HDD), flexible disks (FD), and magnetic tapes. Optical discs include digital versatile discs (DVD), DVD-RAM, compact disc read-only memory (CD-ROM), CD-Recordable (CD-R), and CD-Rewritable (CD-RW). Magneto-optical storage media include magneto-optical discs (MO).

Portable storage media, such as DVD and CD-ROM, are suitable for the distribution of program products. Network-based distribution of software programs is also possible, in which master program files are made available in a server computer for downloading to other computers via a network.

A user computer stores necessary programs in its local storage unit, which have previously been installed from a portable storage media or downloaded from a server computer. That computer executes the programs read out of the local storage unit, thereby performing the programmed functions. As an alternative way of program execution, the computer may execute programs, reading out program codes directly from a portable storage medium. Another alternative method is that the user computer dynamically downloads programs from a server computer when they are demanded and executes them upon delivery.

### Conclusion

The above discussion is summarized as follows. According to the present invention, the proposed reliability verification program on an administrative server searches network configuration data to find a redundant route corresponding to a verification route after removing data records about devices and physical links involved in the verification route from the network configuration data, so as to find two routes that are completely independent of each other. This feature of the present invention enables the administration server to evaluate the redundancy of physical links in a more reliable manner.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. A computer-readable storage medium storing a reliability verification program for verifying reliability of a network system, the program causing a computer to function as:
selection means for selecting a source device and a destination device as a start point and an end point of access routes, with reference to network configuration data describing physical connections of the network system;
verification route determination means for determining a verification route by tracing the physical connections described in the network configuration data from the source device to the destination device;
redundant route finding means for creating network configuration verification data from the network configuration data by excluding data about devices and physical links involved in the verification route that said verification route determination means has determined, and searching the created network configuration verification data to find a redundant route from the source device to the destination device; and
physical connection redundancy determination means for determining that the network system has redundancy in physical connections thereof if said redundant route finding means has successfully found a redundant route corresponding to the verification route.

2. The computer-readable storage medium according to claim 1, wherein:
said verification route determination means determines the verification route by tracing the physical connections described in the network configuration data from one of a plurality of ports of the source device until one of a plurality of ports of the destination device is reached; and
said redundant route finding means finds the redundant route by tracing the physical links from another one of the ports of the source device until another one of the ports of the destination device is reached.

3. The computer-readable storage medium according to claim 1, further causing the computer to function as access path redundancy determination means for receiving information about a plurality of access paths that the source device uses to reach the destination device, and determining whether the access paths have redundancy or not by comparing the given access paths with each qualified pair of the verification route and corresponding redundant route.

4. The computer-readable storage medium according to claim 3, wherein said access path redundancy determination means qualifies the access paths as having good redundancy if one of the access paths is set between source and destination ports of the verification route, and if another one of the access paths is set between source and destination ports of the redundant route corresponding to the verification route.

5. A reliability verification method for verifying reliability of a network system, comprising the steps of:
(a) selecting a source device and a destination device as a start point and an end point of access routes, with reference to network configuration data describing physical connections of the network system;
(b) determining a verification route by tracing the physical connections described in the network configuration data from the source device to the destination device;
(c) creating network configuration verification data from the network configuration data by excluding data about devices and physical links involved in the determined verification route, and searching the created network configuration verification data to find a redundant route from the source device to the destination device; and
(d) determining that the network system has redundancy in physical connections thereof if a redundant route corresponding to the identified verification route is found at said creating and finding step (c).

6. A reliability verification device for verifying reliability of a network system, comprising:
selection means for selecting a source device and a destination device as a start point and an end point of access routes, with reference to network configuration data describing physical connections of the network system;
verification route determination means for determining a verification route by tracing the physical connections described in the network configuration data from the source device to the destination device;
redundant route finding means for creating network configuration verification data from the network configuration data by excluding data about devices and physical links involved in the verification route that said verification route determination means has determined, and searching the created network configuration verification data to find a redundant route from the source device to the destination device; and
physical connection redundancy determination means for determining that the network system has redundancy in physical connections thereof if said redundant route finding means has successfully found a redundant route corresponding to the verification route.
